(19) United States
(12) Patent Application Publication
(10) Pub. No.: US 2005/0271291 A1
(43) Pub. Date: Dec. 8, 2005

(54) Image processing method for display device

(76) Inventor: Nai-Yueh Liang, Taipei City (TW)

Correspondence Address: BIRCH STEWART KOLASCH & BIRCH, PO BOX 747, FALLS CHURCH, VA, 22040-0747, US

(21) Appl. No.: 10/983,659

(22) Filed: Nov. 9, 2004

(30) Foreign Application Priority Data
Jun. 4, 2004 (TW) 093116252

(51) Int. Cl. G06K 9/36

(52) U.S. Cl. 382/243

(57) ABSTRACT

An image processing method for a display device comprises the steps of: receiving an image signal, determining the maximum brightness of the image signal, dividing the maximum brightness of an imager by the maximum brightness of the image signal to obtain a gain value, multiplying the image signal by the gain value to obtain an image-gaining signal, generating a control signal according to the gain value to control the brightness of the light from the light source to become a multiple of the original brightness of the light from the light source and the inverse of the gain value, and sending the image-gaining signal to the imager and using the controlled light from the light source to form an image.

### BACKGROUND OF THE INVENTION

1. Field of Invention

The invention relates to an image processing method for a display device and, in particular, to an image processing method for a display device with a large dynamic range.

2. Related Art

With the arrival of a multimedia era, the use of display devices, such as a CRT display, a LCD display, a plasma display, an electroluminescent display and a projection display, has become popular more and more in every field.

The image projecting systems can be divided into different types, such as CRT projector, LCD projector and DLP projector. The LCD projector and the DLP projector have come into widespread use because they are suitable for high luminance and high display quality.

However, the dynamic range of the LCD projector and the PLD projector is not large. For instance, the actual dynamic range of a LCD projector is about 300-400:1, and the actual dynamic range of a DLP projector is about 500-600:1 (here, a device has a large dynamic range means that it is able to display an image with high contrast and many-levels of gradation). If the dynamic range of a display device is not large enough, a user cannot differentiate images if the brightness of the images is darker (such as night images).

To solve this problem, U.S. Pat. No. 6,683,657 disclosed a projection display system 3, in which an illumination-light amount modulating means is provided to adjust the light amount illuminated to an optical modulator. As shown in FIG. 1, the light illuminated from a light source 31 is reflected by a reflector 32 and becomes a parallel light beam. After passing an integrator 33, the parallel light beam enters a PS converter 34, and is converted from a non-polarized light beam to a linearly-polarized light beam.

The linearly-polarized light beam then enters the optical device 35 having a rotatable polarizing plate. Afterwards the light beam illuminates to the LCD panel 38 via a plurality of reflection layers 36 and prisms 37. The LCD panel 38 controls the light beam to form an image. The polarizing plate is driven by a motor (not shown in the drawing). Since the polarizing plate rotates continuously, the amount of light entering the LCD panel 38 changes accordingly. The amount of light entering the LCD panel 38 is determined according to the input image signal, and the rotation angle of the polarizing plate, which correspondents to the rotation angle of the motor, is calculated in view of the amount of light.

However, the image projecting system mentioned above has an additional illumination-light amount modulating means, which makes the system heavier and larger, and thus not suitable for a compact projection system. Moreover, the angle of the polarizing plate is adjusted mechanically via a motor, which limits the precision of angle adjustment.

### SUMMARY OF THE INVENTION

In view of the above-mentioned problems, the invention is to provide an image processing method for a display device with an increased dynamic range.

To achieve the above, the image processing method for the display device according to the invention is receiving an image signal, determining the maximum brightness of the image signal, dividing the maximum brightness of an imager by the maximum brightness of the image signal to obtain a gain value, multiplying the image signal by the gain value to obtain an image-gaining signal, generating a control signal according to the gain value to control the brightness of the light from the light source to become a multiple of the original brightness of the light from the light source and the inverse of the gain value, and sending the image-gaining signal to the imager and using the controlled light from the light source to form an image.

From the above, the image processing method for the display device according to the invention obtains a gain value using the input signal, multiplies the input signal by the gain value, and adjusts the brightness of the light to become the multiple of the inverse of the gain value to enhance the dynamic range of the display device. Comparing with the prior art, the display device according to the invention does not need additional parts such as a PS converter, a polarizing plate, and motor. Except the reducing of the overall cost, the size and weight of the device remain unchanged. Moreover, the invention increases the dynamic range using an electronic solution, thus has a higher precision than the mechanical solution in the prior art.

### BRIEF DESCRIPTION OF THE DRAWINGS

The invention will become more fully understood from the detailed description given hereinbelow illustration only, and thus is not limitative of the present invention, and wherein:

FIG. 1 is a schematic diagram of a display device in the prior art.

FIG. 2 is a flow diagram of an image processing method for a display device according to a preferred embodiment of the invention.

FIG. 3 is a schematic diagram showing an example of calculating the image signal A and the image signal A′ in the preferred embodiment.

FIG. 4 is a schematic diagram of a display device according to the preferred embodiment of the invention.

FIG. 5 is a schematic diagram showing an example of calculating the image signal A_{G} and the image signal A_{G}′ in the preferred embodiment.

FIG. 6 is another schematic diagram of a display device according to the preferred embodiment of the invention.

FIG. 7 is a schematic diagram showing a DLP projector according to the preferred embodiment.

FIG. 8 is a schematic diagram showing an LCD display according to the preferred embodiment.

FIG. 9 is a schematic diagram of a display device according to the preferred embodiment of the invention.

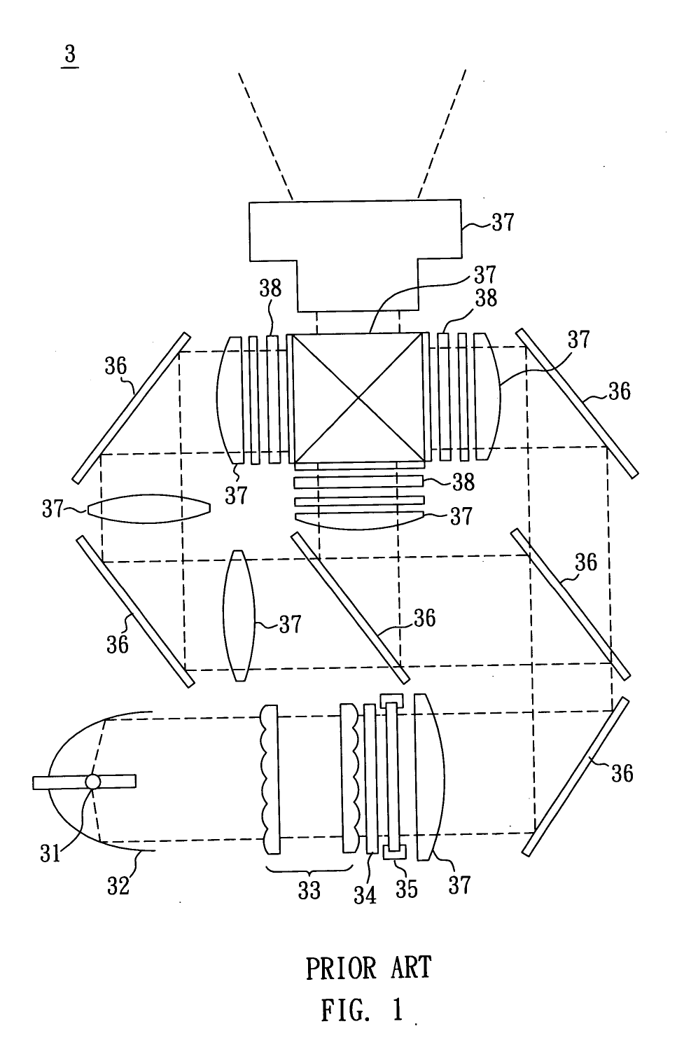

### DETAILED DESCRIPTION OF THE INVENTION

The image processing method for the display devices according to the preferred embodiments of the invention will be described herein below with reference to relevant drawings.

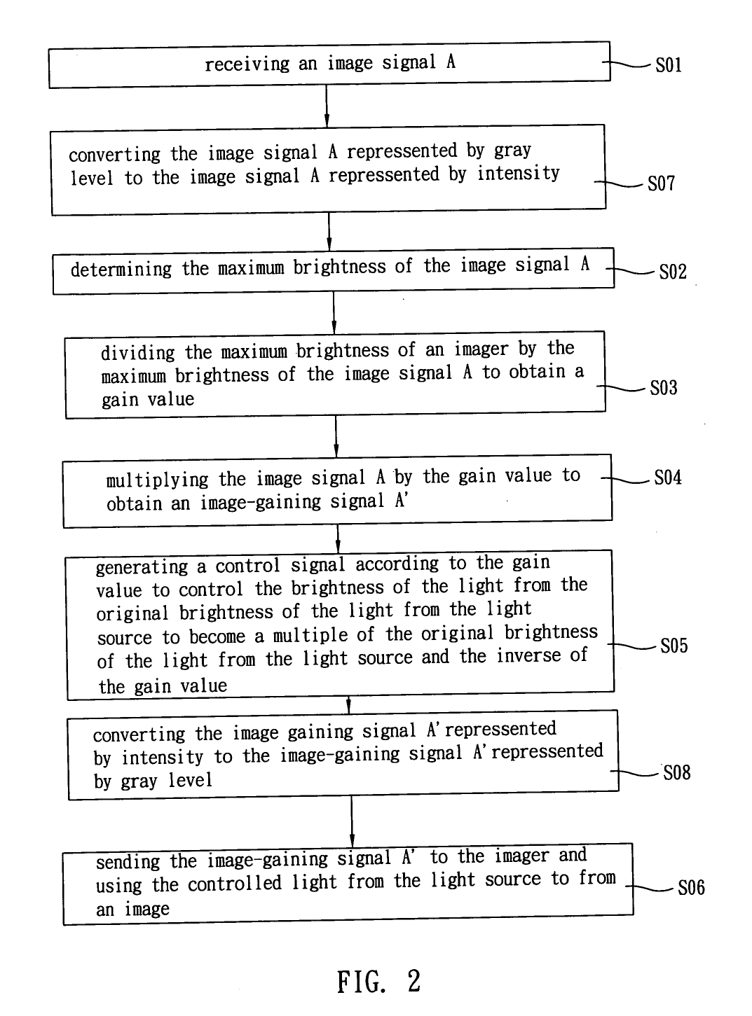

As shown in FIG. 2, the image processing method for the display device according to the preferred embodiment of the invention is receiving an image signal A (S01), determining the maximum brightness of the image signal A (S02), dividing the maximum brightness of an imager by the maximum brightness of the image signal A to obtain a gain value (S03), multiplying the image signal A by the gain value to obtain an image-gaining signal A′(S04), generating a control signal according to the gain value to control the brightness of the light from the light source to become a multiple of the original brightness of the light from the light source and the inverse of the gain value (S05), and sending the image-gaining signal A′ to the imager and using the controlled light from the light source to form an image (S06).

In step S01, receiving the image signal A. Herein, the image signal A can be represented by gray level or intensity.

In step S02, determining the maximum brightness of the image signal A. Herein, the maximum brightness of the image signal A can be represented by gray level or intensity. The image signal A is provided by an image source (not shown in the drawing). For example, the image source may be a computer input terminal, an NTSC input terminal, an LVDS input terminal, a TMDS input terminal, or a D-32 terminal. The image source may be a digital image source or an analog image source. When the image source is an analog image source, analog signals may be converted to digital signals by an AD converter. Moreover, in step S02, an image gaining module or an image-gaining processing module may determine the maximum brightness of the image signal A.

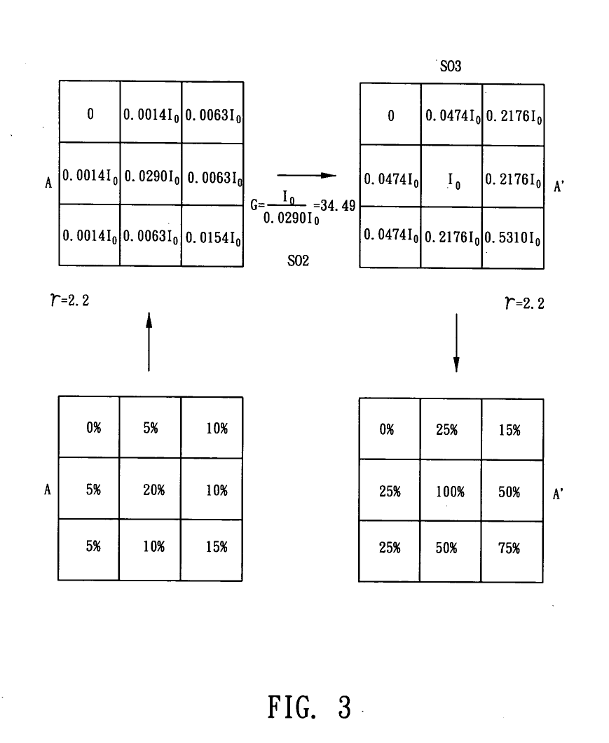

As shown in FIG. 3, in step S03, dividing the maximum brightness of the imager by the maximum brightness of the image signal A to obtain the gain value. Herein, the maximum brightness of the imager can be represented by gray level or intensity. In step S03, the image gaining module or the image-gaining processing module may divide the maximum brightness of the imager by the maximum brightness of the image signal A to obtain the gain value.

Please refer FIG. 3 again, in step S04, multiplying the image signal A by the gain value to obtain the image-gaining signal A′. Herein, an image processing module or the image-gaining processing module may multiply the image signal A by the gain value to obtain the image-gaining signal A′.

In step S05, generating the control signal according to the gain value to control the brightness of the light from the light source to become the multiple of the original brightness of the light from the light source and the inverse of the gain value. Herein, a modulating module may generate the control signal according to the gain value to control the brightness of the light from the light source to become the multiple of the original brightness of the light from the light source and the inverse of the gain value.

In the present embodiment, a light source emits light for image production. The light source may be a digital-controlled or analog-controlled light source. For instance, the light source may be a light-emitting diode (LED), a light bulb, a laser (such as a semiconductor laser), an organic LED, an ultrahigh-press mercury lamp, a metal halide lamp, a xenon lamp or a halogen lamp.

Furthermore, the modulating module is electrically connected with the light source and the image gaining module, and generates a control signal to control the brightness B′ of the light source according to the gain value, wherein the brightness B′ comes out by multiplying the brightness B of the original light by the inverse of the gain value (1/G). That is, B′=B/G For example, if the brightness of the original light is B₀, the brightness of the adjusted light is B₀/G Here, the modulating module 13 may be a digital modulating module or an analog modulating module.

Moreover, the modulating module may also control the open/close time of the light source, so that the brightness B′ of the light emitted by the light source becomes the multiple of the brightness B of the original light and the inverse of the gain value G

In step S06, sending the image-gaining signal A′ to the imager and using the controlled light from the light source to form the image. In other words, the imager receives the image-gaining signal A′, and produces the image using the adjusted light from the light source. This image substantially equals to the image signal A.

As shown in FIG. 2, the image processing method for the display device according to the present embodiment may further include the step of: converting the image signal A represented by gray level to the image signal A represented by intensity (S07).

Since the image signal A can be represented by either intensity or gray level, in the present embodiment, the image signal represented by intensity is called the image intensity signal A_{I}, and the image signal represented by gray level is called the image gray level signal A_{G}. In step S07, the image gray level signal A_{G} can be converted into the image intensity signal A_{I} by the following formula:
A_{I}=I₀×(A_{G})^{γ} (1)
wherein I₀ is the intensity value, A_{G} is the image gray level signal, A_{I} is the image intensity signal, and γ is an arbitrary number (for example, γ is 2.2 for a CRT display).

When the image signal A is the image gray level signal A_{G}, it becomes an image-gaining signal represented by gray level, that is, an image gray level-gaining signal A_{G}′, after multiplied by the gain value G On the other hand, when the image signal A is the image intensity signal A_{I}, it becomes an image-gaining signal represented by intensity, that is, an image intensity-gaining signal A_{I}′, after multiplied by the gain value G.

Please refer FIG. 2 again, the image processing method for the display device according to the present embodiment may further include the step of: converting the image-gaining signal A′ represented by intensity to the image-gaining signal A′ represented by gray level (S08).

In the present embodiment, the image intensity-gaining signal A_{I}′ can be covered into the image gray level-gaining signal A_{G}′ by using the following formula:
A_{G}′=(A_{I}′/I₀)^{1/γ} (4)
wherein I₀ is the intensity value, A_{G}′ is the image gray level-gaining signal, A_{I}′ is the image intensity-gaining signal and γ is an arbitrary number (for example, γ is 2.2 for a CRT display).

Furthermore, the image processing method for the display device according to the present embodiment may further include the step of: converting the image signal represented by intensity to the image signal represented by gray level (S09). Herein, the image intensity signal A_{I} can be converted into the mage gray level signal A_{G} using the following formula:
A_{G}=(A_{I}/I₀)^{1/γ} (2)
wherein I₀ is the intensity value, A_{G} is the image gray level signal, A_{I} is the image intensity signal, and γ is an arbitrary number (for example, γ is 2.2 for a CRT display).

Furthermore, the image processing method for the display device according to the present embodiment may further include the step of: converting the image-gaining signal represented by intensity to the image-gaining signal represented by gray level (S10). Herein, the image gray level-gaining signal A_{G}′ can be covered into the image intensity-gaining signal A_{I}′ using the following formula:
A_{I}′=I₀*(A_{G}′)^{γ} (3)
wherein I₀ is the intensity value, A_{G}′ is the image gray level-gaining signal, A_{I}′ is the image intensity-gaining signal and γ is an arbitrary number (for example, γ is 2.2 for a CRT display).

Step S07, step S08, step S09 and step S10 can be took by a gray level processing module, the image gaining module or the image-gaining processing module.

An example for embodying the present embodiment will be described bellow.

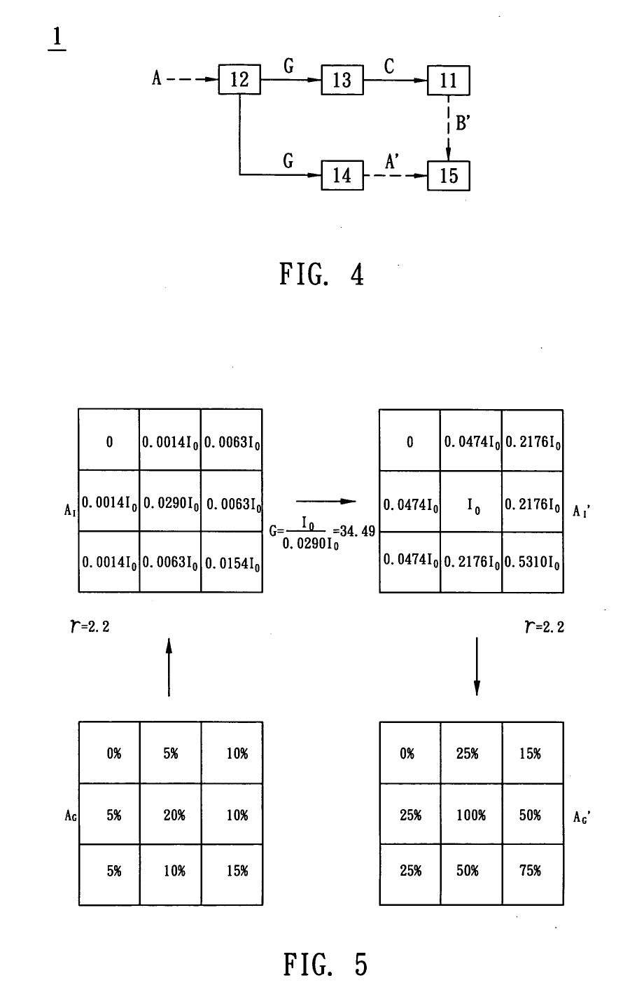

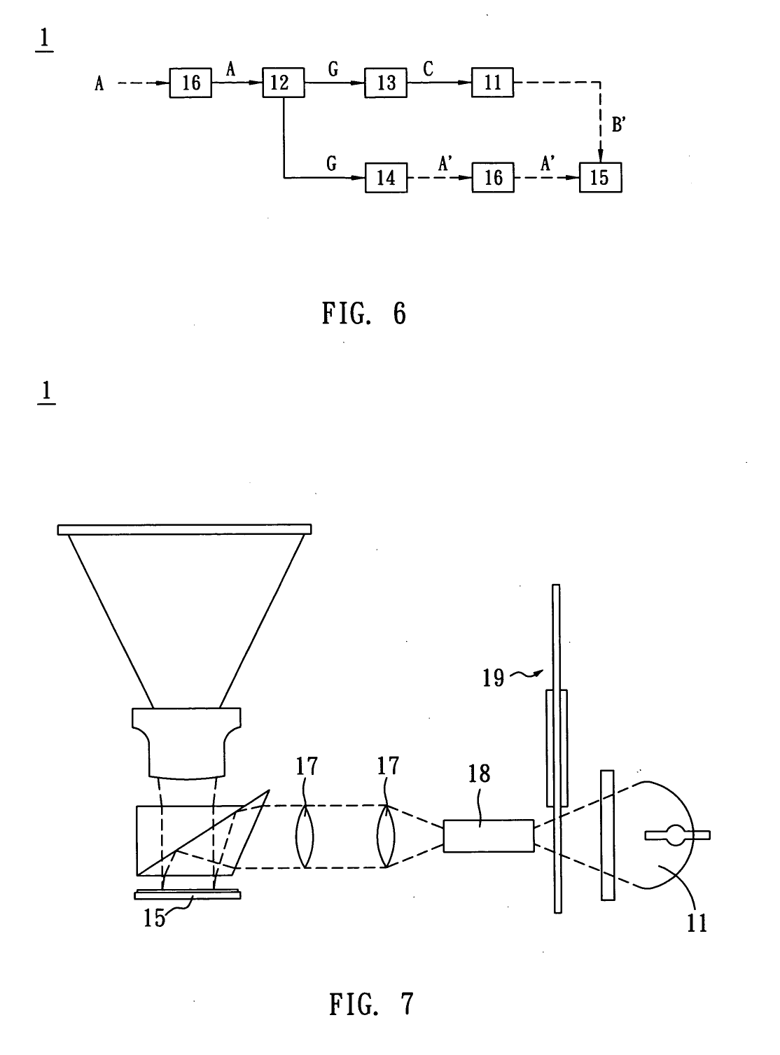

As shown in FIG. 4, the display device 1 includes a light source 11, an image gaining module 12, a modulating module 13, an image processing module 14 and an imager 15. The image gaining module 12 receives the image signal A and generates the gain value G. The modulating module 13 is electrically connected with the light source 11 and the image gaining module 12, and generates the control signal C to control the brightness B′ of the light source 11 according to the gain value G, wherein the brightness B′ comes out by multiplying the brightness B of the original light by the inverse of the gain value (1/G). The image processing module 14 is electrically connected with the image gaining module 12, and generates the image-gaining signal A′ according to the gain value G and the image signal A. The imager 15 is electrically connected with the image processing module 14, receives the image-gaining signal A′, and produces the image using the adjusted light from the light source.

The way of obtaining the gain value and the image-gaining signal A′ will be described with reference to FIG. 5. First, the image gray level signal A_{G} is converted to the image intensity signal A_{I}. Then, the image gaining module 12 determines the maximum intensity of the image intensity signal A_{I}, that is, 0.0290 I₀. Then, the maximum intensity of the imager 15 (I₀) is divided by the maximum intensity of the image intensity signal A_{I} (0.0290I₀) to obtain the gain value G (=34.49). Then, the image processing module 14 generates the image intensity-gaining signal A_{I}′ according to the gain value G (=34.49) and the image intensity signal A_{I}. Lastly, the image intensity-gaining signal A_{I}′ is converted to the image gray level-gaining signal A_{G}′.

In the present embodiment, the display device 1 includes, but not limited to, a DLP projector, a transparent type projector, a reflection type projector, or an LCD display.

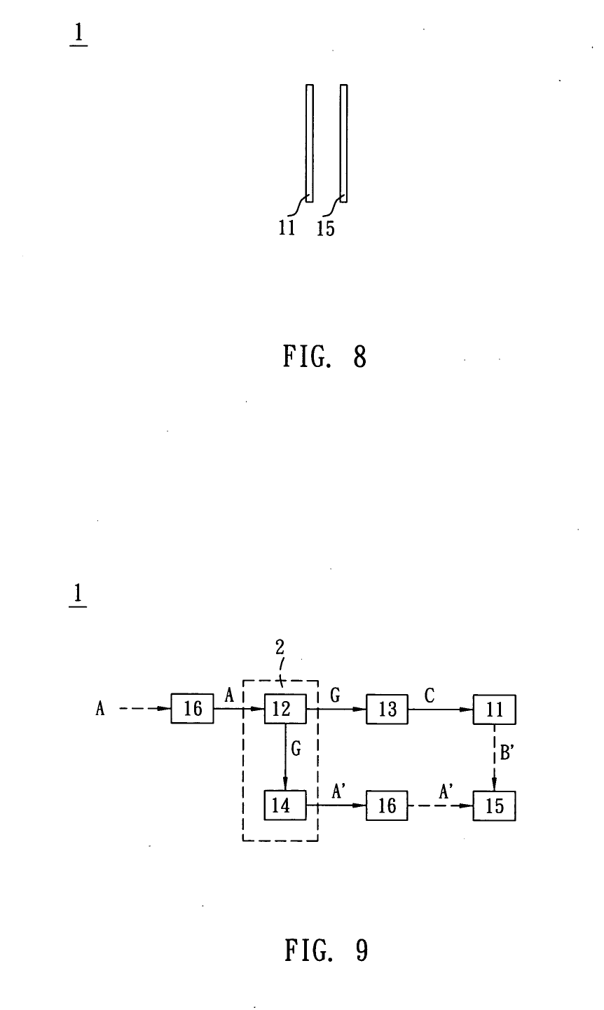

In the present embodiment, the imager 15 includes a display screen when the display device 1 is a projection display device. As shown in FIG. 7, when the display device 1 is a DLP projector, the imager 15 further includes a DMD (digital micro-mirror device). Furthermore, when the display device 1 is a transparent type LCD projector, the imager 15 further includes an LCD light valve. When the display device 1 is a reflection type LCD projector, the imager 15 further includes an LCD reflection panel. As shown in FIG. 8, certainly the display device 1 may be an LCD display, wherein the imager 15 is an LCD panel.

The display device 1 further includes a focus unit 17, as shown in FIG. 7. The focus unit 17 focuses the light emitted by the light source 11. Here, the focus unit 17 is provided on the light path. For example, the focus unit 17 can be provided between the light source 11 and the imager 15.

The display device 1 further includes an optical guide 18, as shown in FIG. 7. The optical guide 18 is provided on the light path to make uniform the light emitted from the light source 11. The optical guide also has the function of light guiding or changing the direction of light. For example, the optical guide 18 may be a light tunnel. Please refer to FIG. 7 again, the optical guide 18 is provided at the two sides of the color wheel 19.

Furthermore, as shown in FIG. 9, the image-gaining processing module 2 may instead of the image gaining module 12 and the image processing module 14. The image-gaining processing module 2 receives the image signal A, generates the gain value G, and generates the image-gaining signal A′ according to the gain value G and the image signal A.

The image processing method for the display device according to the invention obtains a gain value using the input signal, multiplies the input signal by the gain value, and adjusts the brightness of the light to become the multiple of the inverse of the gain value to enhance the dynamic range of the display device. Comparing with the prior art, the display device according to the invention does not need additional parts such as a PS converter, a polarizing plate, and motor. Except the reducing of the overall cost, the size and weight of the device remain unchanged. Moreover, the invention increases the dynamic range using an electronic solution, thus has a higher precision than the mechanical solution in the prior art.

The description should not be construed in a limiting sense. Any modifications and changes within the spirit and scope of the invention should be included in the appended claims.

1. An image processing method for a display device, comprising the steps of:
receiving an image signal;
determining the maximum brightness of the image signal;
dividing the maximum brightness of an imager by the maximum brightness of the image signal to obtain a gain value;
multiplying the image signal by the gain value to obtain an image-gaining signal;
generating a control signal according to the gain value to control the brightness of the light from the light source to become a multiple of the original brightness of the light from the light source and the inverse of the gain value; and
sending the image-gaining signal to the imager and using the controlled light from the light source to form an image.

2. The image processing method for a display device according to claim 1, wherein the image signal is represented by gray level.

3. The image processing method for a display device according to claim 1, wherein the image signal is represented by intensity.

4. The image processing method for a display device according to claim 2, further comprising the step of:
converting the image signal represented by gray level to the image signal represented by intensity.

5. The image processing method for a display device according to claim 3, further comprising the step of:
converting the image signal represented by intensity to the image signal represented by gray level.

6. The image processing method for a display device according to claim 1, wherein the image-gaining signal is represented by gray level.

7. The image processing method for a display device according to claim 1, wherein the image-gaining signal is represented by intensity.

8. The image processing method for a display device according to claim 6, further comprising the step of:
converting the image-gaining signal represented by gray level to the image-gaining signal represented by intensity.

9. The image processing method for a display device according to claim 7, further comprising the step of:
converting the image-gaining signal represented by intensity to the image-gaining signal represented by gray level.

10. The image processing method for a display device according to claim 4, wherein the image signal represented by gray level is converted into the image signal represented by intensity by the following formula:
A_{I}=I₀×(A_{G})^{γ} (1)
wherein I₀ is the intensity value, A_{G} is the image gray level signal, A_{I} is the image intensity signal, and γ is an arbitrary number.

11. The image processing method for a display device according to claim 5, wherein the image signal represented by intensity is converted into the image signal represented by gray level by the following formula:
A_{G}=(A_{I}/I₀)^{1/γ} (2)
wherein I₀ is the intensity value, A_{G} is the image gray level signal, A_{I} is the image intensity signal, and γ is an arbitrary number.

12. The image processing method for a display device according to claim 8, wherein the image-gaining signal represented by gray level is converted into the image-gaining signal represented by intensity by the following formula:
A_{I}′=I₀×(A_{G}′)^{1/γ} (3)
wherein I₀ is the intensity value, A_{G}′ is the image gray level-gaining signal, A_{I}′ is the image intensity-gaining signal, and γ is an arbitrary number.

13. The image processing method for a display device according to claim 9, wherein the image-gaining signal represented by intensity is converted into the image-gaining signal represented by gray level by the following formula:
A_{G}′=(A_{I}′/I₀)^{1/γ} (4)
wherein I₀ is the intensity value, A_{G}′ is the image gray level-gaining signal, A_{I}′ is the image intensity-gaining signal, and γ is an arbitrary number.

14. The image processing method for a display device according to claim 1, wherein the imager receives the image-gaining signal, and produces the image using the adjusted light source, the image substantially equals to the image signal.

15. The image processing method for a display device according to claim 1, wherein the light source is a digital-controlled light source.

16. The image processing method for a display device according to claim 1, wherein the light source is an analog-controlled light source.

17. The image processing method for a display device according to claim 1, wherein the light source is a light-emitting diode (LED), a light bulb, a laser or an organic LED.

18. The image processing method for a display device according to claim 1, wherein the imager comprises a display screen.

19. The image processing method for a display device according to claim 1, wherein the imager comprises an LCD light valve.

20. The image processing method for a display device according to claim 1, wherein the imager comprises an LCD reflection panel.

21. The image processing method for a display device according to claim 1, wherein the imager comprises a digital micro-mirror device.

22. The image processing method for a display device according to claim 1, wherein the imager is an LCD panel.

23. The image processing method for a display device according to claim 1, wherein the display device is of a projection type.
